(19) United States
(12) Patent Application Publication
(10) Pub. No.: US 2009/0112635 A1
(43) Pub. Date: Apr. 30, 2009

(54) Foreign Non-Qualified Deferred Compensation Hybrid Trust Strategy

(76) Inventor: Kenneth Rubinstein, New York, NY (US)

Correspondence Address: RUBINSTEIN & RUBINSTEIN , LLP, 18 EAST 48TH STREET, NEW YORK, NY, 10017, US

(21) Appl. No.: 12/260,833

(22) Filed: Oct. 29, 2008

Related U.S. Application Data
(60) Provisional application No. 60/983,628, filed on Oct. 30, 2007.

(51) Int. Cl. G06Q 40/00

(52) U.S. Cl. 705/4; 705/35; 705/36 T

(57) ABSTRACT

Rubinstein & Rubinstein, LLP has developed a new, tax compliant invention which allows a U.S. taxpayer who is an employee of an entity based in a foreign jurisdiction, and/or the Employee's family, to minimize taxation on distributions from a foreign non-qualified deferred compensation plan. The strategy applies to foreign entities that have established deferred compensation plans for U.S. employees in compliance with IRS rules and regulations. The invention differs from generic deferred compensation plans because it allows a U.S. person to attain the benefits of participating in a deferred compensation plan all while maintaining minimized taxation on distributions from the plan.

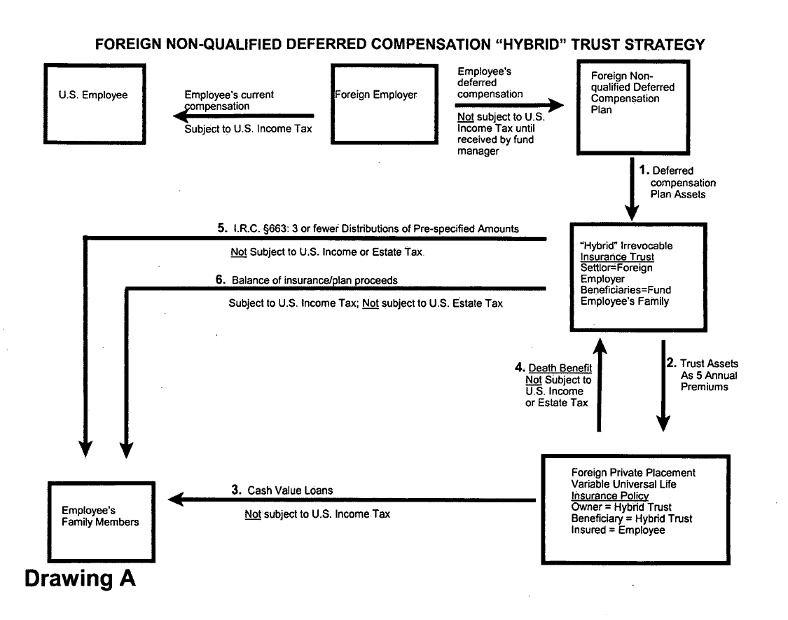

### CROSS REFERENCE TO RELATED APPLICATIONS

This patent application corresponds to U.S. provisional patent application No. 60/983,628 filed on Oct. 30, 2007 entitled “Foreign Non-Qualified Deferred Compensation ‘Hybrid’ Trust Strategy”.

### BACKGROUND OF THE INVENTION

1. Field of the Invention

The present invention related to a tax compliant method which allows a U.S. taxpayer who is an employee (“Employee”) of a firm based in a foreign (non-U.S.) jurisdiction (“Employer”), and/or the Employee's family, to minimize taxation on distributions from a foreign non-qualified deferred compensation plan. The method applies to foreign firms that have established deferred compensation plans for U.S. employees in compliance with Internal Revenue Service rules and regulations.

2. Background Art

Under a typical deferred compensation arrangement, including those that use an irrevocable insurance trust, plan payments and death benefits are taxable, in varying percentages, to the distributee, whether the Employee or a secondary beneficiary. Moreover, any death benefit will be included in the Employee's estate.

By establishing a tax compliant irrevocable insurance trust pursuant to this invention, Employee's family may realize the benefits of the deferred compensation plan while incurring minimal tax liability. If properly structured, Employee's family may presently realize the benefits of the deferred compensation plan through tax free loans against insurance cash value, and receive death benefit proceeds income and estate tax free.

### SUMMARY OF THE INVENTION

The strategy applies to foreign entities (“the employer”) that have established deferred compensation plans (the “Plan”) for U.S. employees in compliance with Internal Revenue Service rules and regulations.

The Employer is to establish a trust, funded with Plan assets, that will purchase foreign private placement variable universal life insurance on behalf of the Employee.

In order to purchase foreign insurance, the trust must be foreign based, as foreign insurance providers will not sell insurance to U.S. persons or entities. However, under IRS rules and regulations, when the Employer transfers Plan assets to a foreign trust, the assets are immediately taxable as income to the U.S. Employee (assets transferred to a foreign trust will be includible in the Employee's gross income, IRC §409A(b)(1)), in effect negating the benefits of the deferred compensation plan. The penalties of IRC §409A may be avoided while still allowing the Employee to benefit from the tax advantages provided by foreign variable universal life insurance, if the Plan transfers assets to a “hybrid” trust.

The “Hybrid Trust” is a trust that is registered in a foreign jurisdiction but that also qualifies as a U.S. trust for IRS purposes. In order for the trust to qualify as a “Hybrid Trust”, it must provide that: (1) a U.S. court can exercise primary supervision over trust assets and over the administration of the trust, and (2) a U.S. person has authority to control all substantial decisions of the trust (i.e. a trustee). The trust instrument can provide that the trust will be governed by the law of the foreign jurisdiction in which the trust is registered so long as the trust instrument also states that the administration of the trust will take place in the United States (IRC §7701(a)(30)(E); Treas. Reg. §301.7701-7(a)).

If a U.S. court can exercise primary supervision over the administration of the trust and a trustee who is a U.S. person is exclusively responsible for all substantial decisions of the trust, the trust will qualify as a U.S. trust even though it is registered in a foreign jurisdiction. The trustee should be independent of the Employee in order to avoid any claims that the Employee controls the trust and prevent the inclusion of trust assets in the Employee's estate. The trust may have a foreign co-trustee, but its responsibilities must be purely ministerial. It is mandatory that the foreign co-trustee be prohibited from exercising any substantial decision making authority in order for the trust to qualify as a U.S. trust.

The Employer will establish the trust with characteristics of both a “Rabbi trust” and an irrevocable life insurance trust. A rabbi trust offers an employee increased protection against depletion of deferred funds (i.e. Plan assets) while remaining compliant with IRS standards. A rabbi trust is an irrevocable trust arrangement in which the funds sufficient to satisfy a deferred compensation arrangement may be used only to compensate the employee—as per the deferred compensation plan—but those funds will be available to satisfy the claims of the Employer's creditors. A rabbi trust must provide that: (1) trust assets are subject to the claims of the Employer's creditors in the event of the Employer's insolvency; (2) the Employee and his beneficiaries have no preferred claim to, nor any beneficial ownership interest in Plan assets, and (3) the Plan trustee will be notified in the event of the Employer's insolvency and shall immediately cease payment under the deferred compensation plan. In the event of the Employer's insolvency, all trust assets will be transferred to the Employer. By establishing the trust as described and funding it with Plan assets, the Employee is not considered to have received any real or constructive benefit from the assets.

The terms of the trust instrument will also provide the trust with characteristics of an irrevocable life insurance trust. An irrevocable life insurance trust is a well-recognized estate planning tool designed to remove life insurance proceeds from the estate of the insured. The irrevocable life insurance trust functions by allowing the trustee to assume all “incidents of ownership” of policies on the insured's life (e.g. the right to change the beneficiary or the right to assign the policy to someone else). According to the terms of the trust, the insured must have no control over such policies. This removes the policies from the insured's taxable estate. The irrevocable life insurance trust is the beneficiary of the policies and, in turn, the insured's heirs are named beneficiaries of the insurance trust. Upon the death of the insured, the insurance death benefit is paid to the insurance trust, and the trustee distributes the proceeds, in accordance with the terms of the trust, to the beneficiaries of the trust. Because the insured does not possess any “incidents of ownership” on the policies, the assets are not included in his taxable estate.

With Plan assets, the trustee then purchases foreign private placement variable universal life insurance upon the life of the Employee. As long as the trust is the owner and beneficiary of the insurance policy, the Employee should not be deemed to have constructively received or benefitted from the deferred compensation. The insurance policy should provide that the beneficiaries of the trust (i.e., Employee's family members) may borrow against the cash value of the life insurance policy, subject to Trustee approval. Loans are repayable on demand of trustee in event of Employer insolvency. Such loans are not taxable as income provided the life insurance is not a modified endowment contract (IRC §§72(e), 7702A). By borrowing against the cash value of the policy, the Employee's family members can access the deferred compensation Plan assets while the Employee is still alive, i.e., even before the death benefits of the insurance policy are distributed to the trust. Outstanding loan balances will be deducted from the death benefit paid to the trust upon the Employee's death. The terms of the trust should include a clause that no loans can be granted earlier than two years from the policy purchase to protect against claims that the Plan has a principle purpose of tax avoidance, and to prevent any possibility of recharacterizing the loan as a taxable trust distribution. The IRS rule regarding the recharacterization of foreign loans states that a plan cannot be deemed to have a principal purpose of tax avoidance if the loans are made from funds transferred to the intermediary more than two years before (Treas. Reg. §1.643(h)-1(a)).

The trust document should specify that, commencing one year and one day after the death of the Employee, the trustee shall distribute specific dollar amounts to the trust beneficiaries in no more than three installments. Beneficiaries of the trust will not pay U.S. income or estate tax on these distributions. Any remaining cash value of the policy and death benefit payments will be subject to income tax upon distribution to the trust beneficiaries (IRC §663).

### DESCRIPTION OF THE DRAWING

These and other advantages of the present invention will be readily understood with reference to the following specification and attached drawing wherein:

DRAWING A is a diagram of the method in accordance with the present invention.

### DETAILED DESCRIPTION OF THE INVENTION

Foreign Employer creates “Hybrid” irrevocable insurance trust and funds trust with deferred compensation plan assets. “Hybrid” trust: U.S. trust for IRS purposes—compliant with IRC §7701(a)(30)(E); foreign trust for foreign insurance company purposes: (a) Foreign Employer is settlor of Trust. Employee's family members are beneficiaries of Trust; (b) trust is registered in foreign jurisdiction. Trust may be subject to foreign law; (c) trust administration must take place in U.S.; (d) trust must provide for U.S. court's primary jurisdiction over all trust assets; (e) U.S. trustee must be exclusively responsible for all substantial decisions; (f) multiple trustees are allowed, but at least one must be U.S. person and any foreign trustee may only have ministerial duties; (g) trust must include “Rabbi” trust provisions: (1) In event of Employer's insolvency, trust assets will be subject to claims of Employer's creditors, (2) Trustee will be notified in event of Employer's insolvency, will discontinue distributions to beneficiaries and will transfer trust assets to Employer, and (3) Employee and beneficiaries have no preferred claim to, nor beneficial ownership of, trust assets; (h) Employee may not exercise any control over trust. Trustees should be independent—not controlled by employee; if Employer is controlled by Employee, trustees should not be employed by Employer; and (i) Employer should provide written notice to Employee that it intends to create trust which may acquire life insurance on Employee and obtain Employee's written consent (IRC §101(j)).

Trust purchases foreign private placement variable universal life insurance policy on Employee's life. Foreign insurance is utilized because of unlimited flexibility of investments (including foreign investments otherwise inaccessible to U.S. investors) and lower cost. Trust is registered in a foreign jurisdiction because foreign insurers will not sell to U.S. persons. Thus, trust is a “hybrid” trust—U.S. Trust pursuant to IRC §7701(a)(30)(E) for U.S. tax purposes, foreign trust for insurance purposes. Insurance Policy must qualify as life insurance contract pursuant to IRC §7702. Policy investments should be diversified pursuant to IRC §817. Insurance Policy provides that: Employee is the insured; Trust is the owner of the policy; Trust is the beneficiary of the policy; Policy loans may be issued against cash value after two year waiting period; and Trust beneficiaries (Employee's family members) may borrow against policy cash value (as indirect policy beneficiaries) with trustee's approval. The loans are repayable on demand of the trustee in the event of Employer insolvency. Trust transfers assets to policy in five annual premium payments to avoid classification as modified endowment contract (IRC §§72(e),7702A). Employee may not exercise any control over insurance policy and may not have any other incidents of ownership over policy.

Employee's family members obtain trustee's approval and (after two years) obtain policy loans against cash value of the policy directly from insurer. Policy loans are repaid at Employee's death by being deducted from policy death benefit. Policy loans are U.S. tax-free.

Upon Employee's death, insurer pays policy death benefit (less outstanding loans) to trust. Death benefit is U.S. tax-free.

One year and one day after Employee's death, trustee distributes pre-specified amounts in three or fewer payments to trust beneficiaries (Employee's family members). Amounts must be specified in trust Deed of Settlement (IRC §663). Specified distributions are U.S. tax-free.

Trustee also distributes any excess trust assets per trust provisions. Excess distributions are U.S. estate tax-free but are subject to U.S. income tax as deferred compensation plan distributions.

### STATEMENT REGARDING FEDERALLY SPONSORED RESEARCH OR DEVELOPMENT

Not applicable.

### REFERENCE TO COMPACT DISC

Not applicable.

What is claimed is:

1. A tax compliant method to allow a U.S. taxpayer who is an employee of a firm based in a foreign (non-U.S.) jurisdiction, and/or the employee's family, to minimize taxation on distributions from a foreign non-qualified deferred compensation plan.

2. The method recited in claim 1, further comprising: Foreign employer creates “Hybrid” irrevocable insurance trust and funds trust with deferred compensation plan assets; foreign employer is the grantor and the employee's family are the beneficiaries.

3. The method recited in claim 2, further comprising: “Hybrid” trust is a U.S. trust for Internal Revenue Service purposes and a foreign trust for foreign insurance company purposes.

4. The method recited in claim 2, further comprising: Trust is registered in a foreign jurisdiction, and may be subject to foreign law, but trust administration must take place in the U.S.

5. The method recited in claim 2, further comprising: Trust must provide for U.S. court's primary jurisdiction over all trust assets.

6. The method recited in claim 2, further comprising: U.S. trustee must be exclusively responsible for all substantial decisions.

7. The method recited in claim 2, further comprising: U.S. trustee must be exclusively responsible for the decision whether and when to distribute trust income or principal.

8. The method recited in claim 2, further comprising: U.S. trustee must be exclusively responsible for the amount of any distribution.

9. The method recited in claim 2, further comprising: U.S. trustee must be exclusively responsible for the selection of beneficiary.

10. The method recited in claim 2, further comprising: U.S. trustee must be exclusively responsible for the allocation of trust receipts to income or principal.

11. The method recited in claim 2, further comprising: U.S. trustee must be exclusively responsible for the decision whether to terminate the trust.

12. The method recited in claim 2, further comprising: U.S. trustee must be exclusively responsible for the decision whether to compromise, arbitrate or abandon claims.

13. The method recited in claim 2, further comprising: U.S. trustee must be exclusively responsible for the decision whether to sue or defend suits.

14. The method recited in claim 2, further comprising: U.S. trustee must be exclusively responsible for the decision whether to remove, add or replace a trustee, or appointment of successor trustee.

15. The method recited in claim 2, further comprising: U.S. trustee must be exclusively responsible for the investment decisions.

16. The method recited in claim 2, further comprising: Multiple trustees are allowed, but at least one must be U.S. person; foreign trustee may only have ministerial duties.

17. The method recited in claim 2, further comprising: Trust must include provision that in event of Employer's insolvency, trust assets will be subject to claims of employer's creditors.

18. The method recited in claim 2, further comprising: Trust must include provision that trustee will be notified in event of Employer's insolvency, will discontinue distributions to beneficiaries and will transfer trust assets to employer.

19. The method recited in claim 2, further comprising: Trust must include provision that Employee and beneficiaries have no preferred claim to, or beneficial ownership of, trust assets.

20. The method recited in claim 2, further comprising: Employee may not exercise any control over the trust or trustee.

21. The method recited in claim 2, trustees should not be employed by Employer.

22. The method recited in claim 2, further comprising: Employer should provide written notice to Employee that it intends to create trust which may acquire life insurance on Employee and obtain Employee's written consent.

23. The method recited in claim 2, further comprising: Trust purchases foreign private placement variable universal life insurance policy on employee's life.

24. The method recited in claim 23, further comprising: Insurance policy must qualify as a life insurance contract pursuant to Internal Revenue Code section 7702.

25. The method recited in claim 23, further comprising: Insurance policy provides that Employee is the insured.

26. The method recited in claim 23, further comprising: Insurance policy provides that Trust is the beneficiary of the policy.

27. The method recited in claim 23, further comprising: Insurance policy provides that Trust is the owner of the policy.

28. The method recited in claim 23, further comprising: Insurance policy provides that policy loans may be issued against cash value after two year waiting period.

29. The method recited in claim 23, further comprising: Insurance policy provides that trust beneficiaries may borrow against policy cash value with trustee's approval.

30. The method recited in claim 23, further comprising: Trust transfers assets to policy in five annual premium payments to avoid classification as modified endowment contract.

31. The method recited in claim 23, further comprising: Employee may not exercise any control over insurance policy and may not have any other incidents of ownership over policy.

32. The method recited in claim 23, further comprising: Policy loans are repaid at employee's death by being deducted from policy death benefit.

33. The method recited in claim 29, further comprising: Employee's family members may obtain trustee's contingent approval to obtain policy loans against cash value of the policy directly from insurer.

34. The method recited in claim 26, further comprising: Upon employee's death, insurer pays policy death benefit to trust.

35. The method recited in claim 2, further comprising: One year and one day after employee's death, trustee distributes pre-specified amounts in three or fewer payments to trust beneficiaries.

36. The method recited in claim 35, further comprising: The amount of payments to trust beneficiaries must be specified in trust Deed of Settlement.

37. The method recited in claim 2, further comprising: Upon employee's death, trustee also distributes any excess trust assets per trust provisions.

38. The method recited in claim 37, further comprising: Excess trust assets are U.S. estate tax free but are subject to U.S. income tax as deferred compensation plan distributions.
